(19) United States
(12) Patent Application Publication
(10) Pub. No.: US 2005/0098394 A1
(43) Pub. Date: May 12, 2005

(54) Mounting plate for a linear damper

(76) Inventor: Armin Baldreich, Lauterach (AT)

Correspondence Address: WENDEROTH, LIND & PONACK, L.L.P., 2033 K STREET N. W., SUITE 800, WASHINGTON, DC, 20006-1021, US

(21) Appl. No.: 10/983,601

(22) Filed: Nov. 9, 2004

(30) Foreign Application Priority Data
Nov. 10, 2003 (AT) GM 785/2003

(51) Int. Cl. F16C 17/00

(52) U.S. Cl. 188/67; 188/381

(57) ABSTRACT

A mounting plate (4) for a linear damper (3) with a cylinder (16), a piston and a piston rod (17). The cylinder (16) of the linear damper (3) is held between holding jaws (15) of the mounting plate. The holding jaws (15) of the mounting plate (4) form a movable bearing in which the cylinder is axially displaceable. A stop (21) is provided, which is made at least partially of a material with rubber elastic properties, which strikes against the cylinder (16) of the linear damper (3) during damping.

The invention relates to a mounting plate for a linear damper having a cylinder, a piston and a piston rod, said cylinder of the linear damper is held between holding jaws of the mounting plate, furthermore, a damper arrangement and a pull-out guide for drawers or similar with a drawer rail fitted to the drawer and a mounting rail fitted to a body of furniture, whereby a linear damper with a cylinder having a movable piston therein is arranged on one of the rails, and said damper brakes the drawer rail.

The object of the invention is to achieve optimal anchoring of the linear damper on one of the rails of the pull-out guide fitting and to allow the simple exchange of a defective linear damper.

According to the invention, this object is achieved in that the holding jaws of the mounting plate form a loose bearing in which the cylinder is axially displaceable.

Advantageously there is provision that the mounting plate, which is rectangular in top view, has lateral grooves and a frontally projecting hook and preferably the mounting rail has a ridge with a longitudinal slot, whereby the mounting plate is inserted in the longitudinal slot in such a way that the lateral edges of the slot project into the lateral grooves of the mounting plate and the hook on the front end of the mounting plate snaps in a recess of the ridge, said recess being provided on the front face of the longitudinal slot and at a distance therefrom.

With the mounting plate according to the invention, the linear damper can simply be pressed between the holding jaws and is thus immediately functional. No tools are needed to press in the linear damper or to dismantle the linear damper.

The cylinder of the linear damper is held resiliently or spring-clamped by the holding jaws. It is held captive in the mounting plate, but can be axially displaced in the mounting plate during the damping process.

A further object of the invention is to improve the damping effect.

This object is achieved in a damper arrangement for movable parts of furniture with a damper with a movable damper part and a stop which is movable relative to the damper, and impacts on the moving damper part during the damping process and thus effects the damping, especially for use with a mounting plate according to claim 1, by the fact that the stop consists at least partially of a material with rubber elastic properties.

In the following, an embodiment of the invention will be described in more detail with reference to the accompanying drawings, in which:

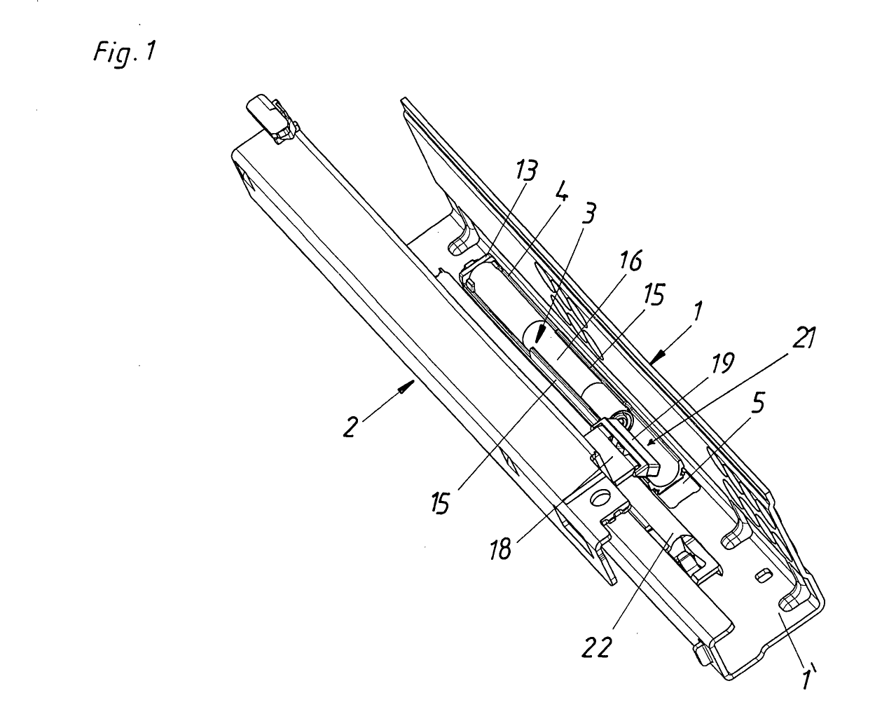

FIG. 1 is a diagram of a pull-out device according to the invention,

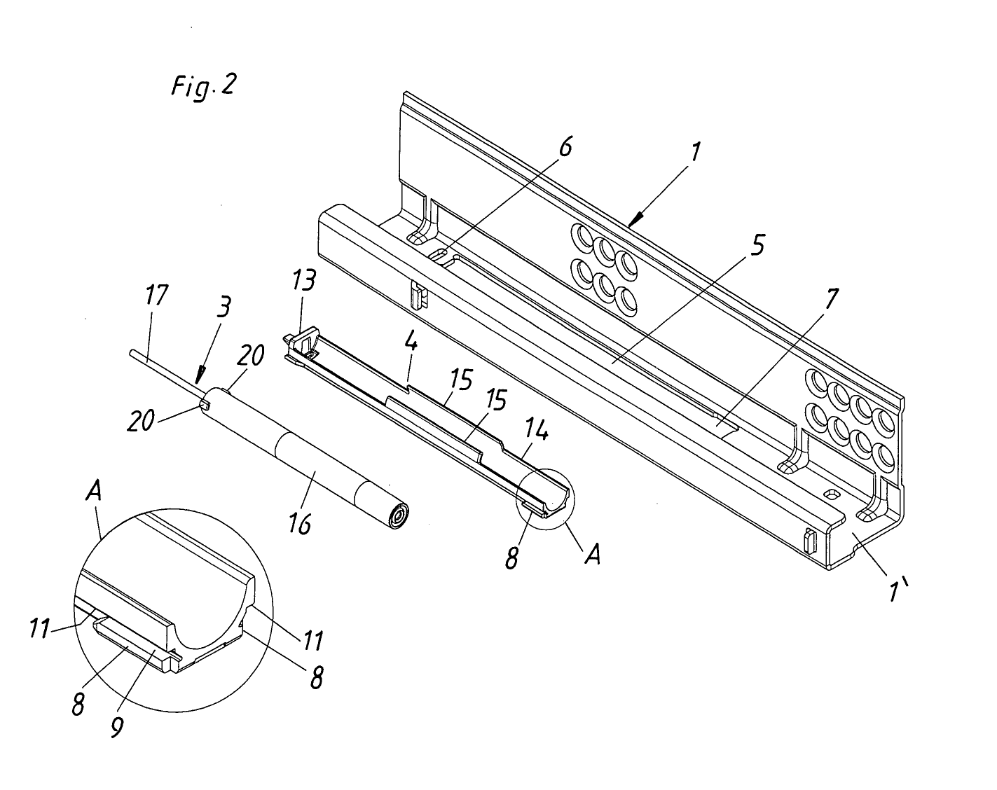

FIG. 2 is a diagram of a mounting rail of a mounting plate according to the invention, and of a linear damper, whereby the parts are drawn pulled apart;

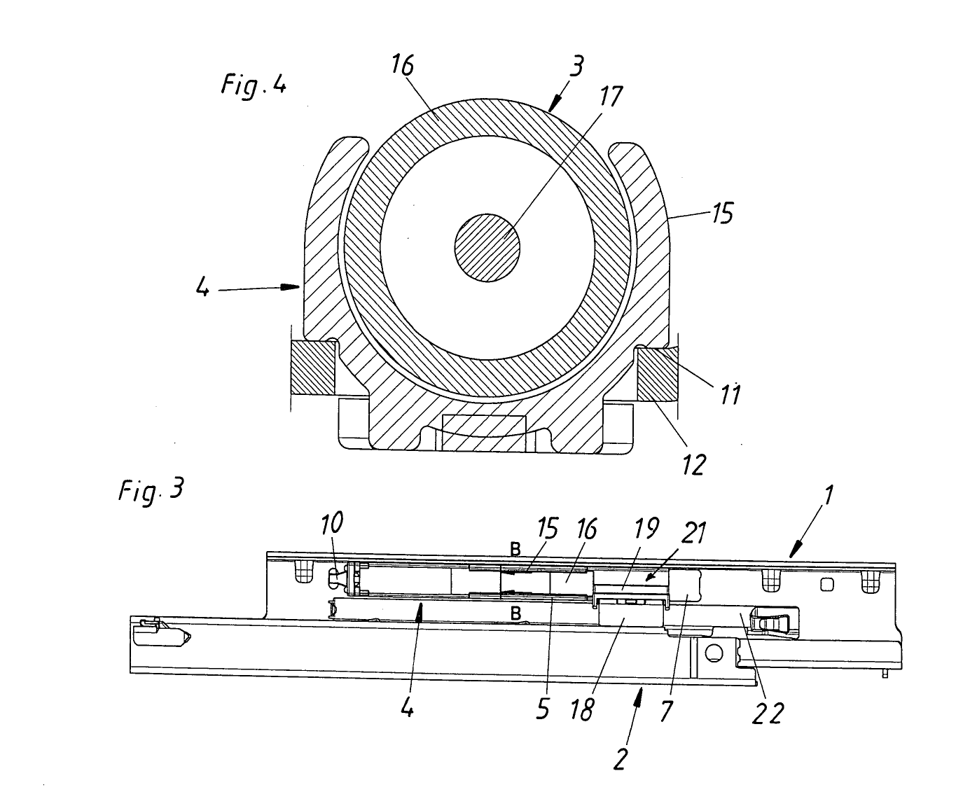

FIG. 3 is a top view of a pull-out device according to the invention,

FIG. 4 is the sectional view along line B-B of FIG. 3,

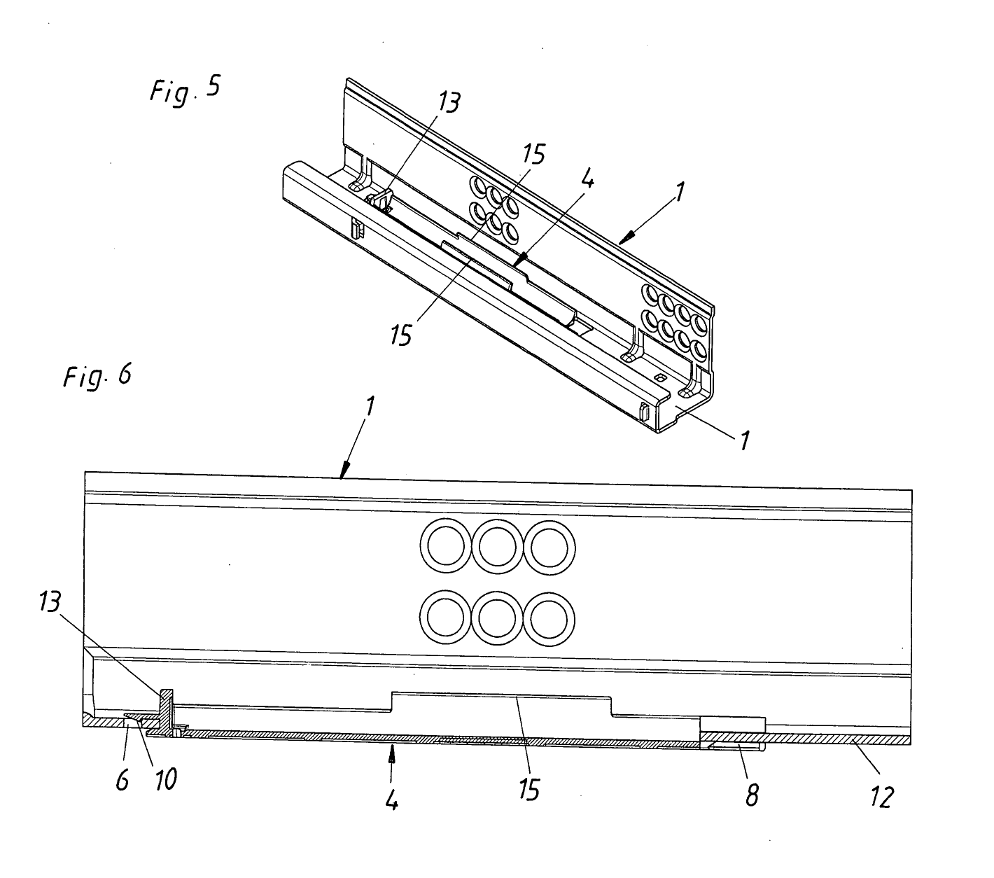

FIG. 5 is a diagram of a mounting rail and a mounting plate mounted thereon,

FIG. 6 is a vertically-aligned longitudinal sectional view through the mounting rail in the area of the mounting plate,

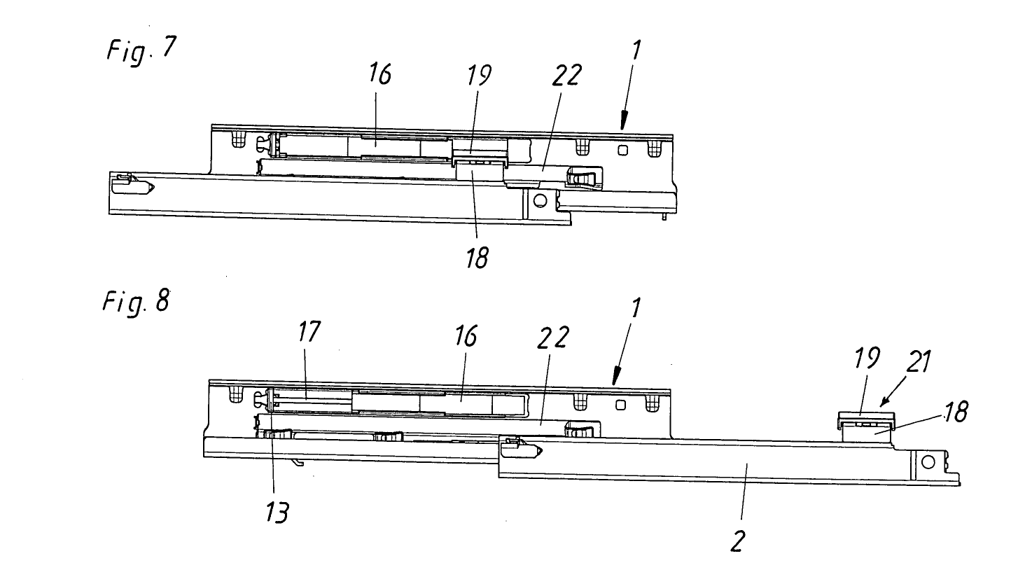

FIG. 7 is a top view of a pull-out device according to the invention in the pushed-in position,

FIG. 8 is a top view of a pull-out device according to the invention in the pulled-out position,

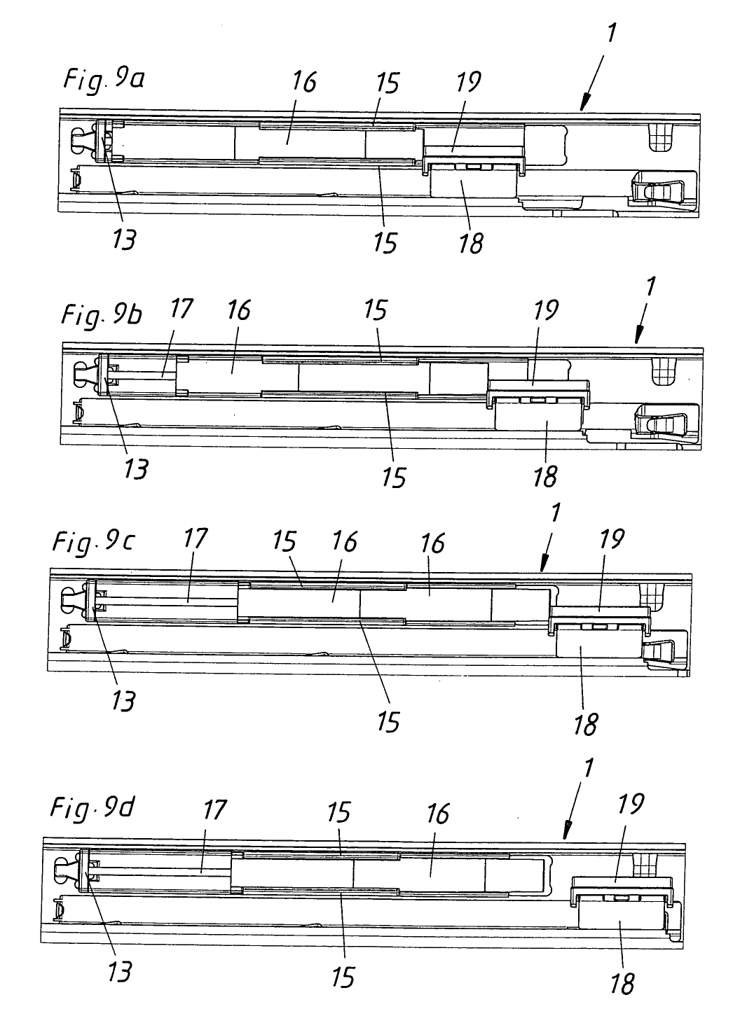

FIG. 9a is a schematically contrasted top view of a pull-out device according to the invention at the end of the damping path,

FIG. 9b, 9c show top views of the damper and the stop on the drawer rail during damping,

FIG. 9d is a top view of the damper and the stop on the drawer, with the damper shown in the ready position,

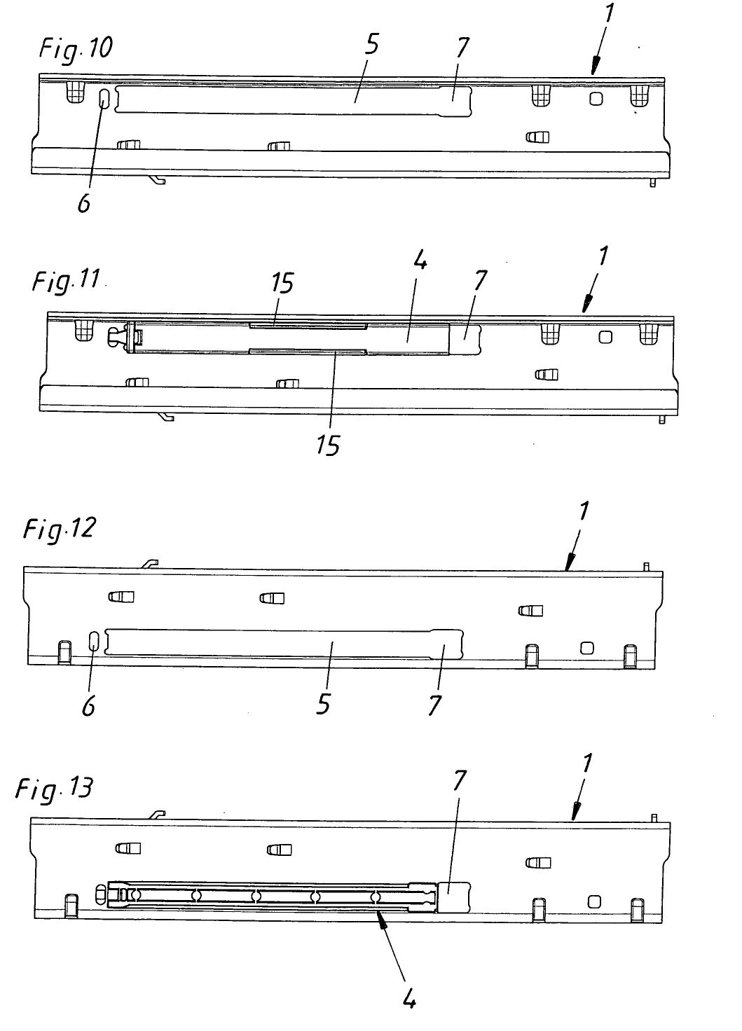

FIG. 10 is a top view of the mounting rail without mounting plate,

FIG. 11 is a top view of the mounting rail with mounting plate fitted, and

FIG. 12 is a bottom view of the mounting rail without mounting plate,

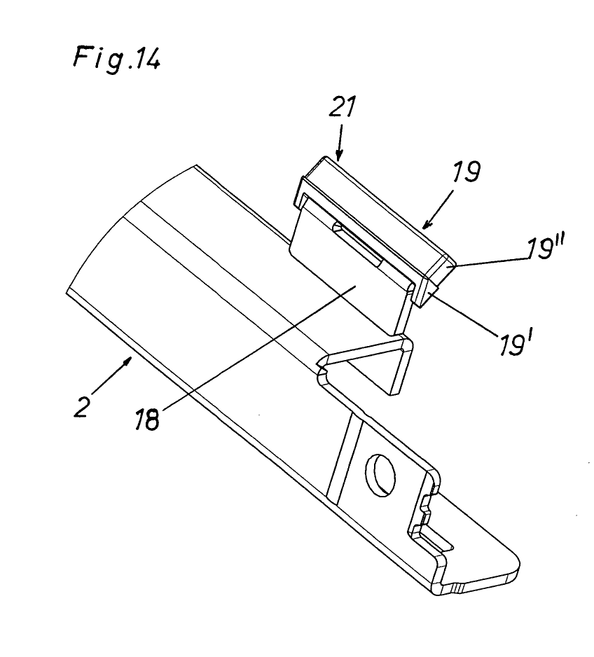

FIG. 13 is a bottom view of the mounting rail with the mounting plate fitted, and

FIG. 14 is a diagram of the frontal area of the drawer rail with the stop.

There is a pull-out guide consisting of mounting rail 1 and drawer rail 2 on each side of the drawer. The load of the drawer rail 2 on the mounting rail 1 is transferred via rollers which are mounted on the rails 1, 2 or in carriages, which run differentially between the rails 1, 2. A linear damper 3 can be provided on both sides of the drawer or else on one side only. It is an essential advantage of the invention that one of the rails 1, 2, in this case the mounting rail 1, can be quickly and easily fitted with a linear damper 3. The linear damper 3 is accepted into a mounting plate 4 which is anchored in the horizontal ridge 1′ of the mounting rail 1. The horizontal ridge 1′ has a longitudinal slot 5, in which the mounting plate 4 is inserted. On one front face of the longitudinal slot 5 there is a slot-shaped recess 6, which is aligned at right angles to the longitudinal slot 5.

On the end opposite the recess 6 the longitudinal slot 5 is provided with an extension 7.

The mounting plate 4 has lateral ridges 8 at one end which delimit grooves 9. At the other end the mounting plate 4 is provided with a hook 10. The mounting plate 4 with the hook 10 is made from plastic and the hook 10 is designed to be elastic.

To fit the mounting plate 4 on the mounting rail 1, said mounting plate 4 is inserted in the slot 5 in such a way that it lies with its support edges 11 on the slot edges 12 and that the ridges 8 are disposed in the area of the extension 7. After that the mounting plate 4 is displaced until the hook 10 snaps into the recess 6. In this position, the edges 12 of the longitudinal slot 5 engage in the grooves 9 on the opposite end of the mounting plate 4.

The mounting plate 4 has a trough-shaped area 14 and a front wall 13. In the middle area, the mounting plate 4 is provided with two holding jaws 15, which in the embodiment shown are moulded out of plastic in a single piece with the mounting plate 4. The linear damper 3 is inserted into the trough-shaped area 14 of the mounting plate 4 in such a way that it is clipped, with its cylinder 16, between the holding jaws 15. The piston rod 17 thereby strikes against the front plate 13 of the mounting plate 4.

The holding jaws 15 form a loose bearing for the cylinder 16 of the linear damper 3, i.e. although the cylinder 16 is anchored on the mounting plate 4, it can be displaced longitudinally.

The pull-out rail 2 has a laterally-projecting tab 18 which is provided with a cap 19 made of plastic. The tab 18 and the cap 19 form a stop 21 for the linear damper 3. The cap 19 is designed as a two-component moulded part with a harder area 19′, which is slid directly onto the tab 18, and a softer area 19″, on which the cylinder 16 of the linear damper 3 impacts laterally when the drawer closes.

When the pull-out rail 2 is brought into the rear closed position, the stop 21 impacts with the cap 19 at the door side on the cylinder 16 of the linear damper 3 and the cylinder 16 is pushed backwards. The piston rod 17 then rests upon the front wall 13 and thus there is a relative movement between the piston, which is inside the cylinder 16, and the cylinder 16. The linear damper 3 is preferably designed as a fluid damper. The fluid can be either a gas or air or a liquid.

In the cylinder 16, there is a return spring.

If the drawer is opened, i.e. the drawer rail 2 is drawn to the right according to FIG. 1, then the return spring forces the cylinder 16 into the initial position, until it abuts with its lateral stops 20 on the leading edges of the holding jaws 15. The linear damper 3 is then back in the ready position.

Next to the mounting plate 4 and the linear damper 3 there is disposed a retraction guide 22 which draws the drawer rail 2 into the final closed position. This type of retraction device is described, for example, in the German utility model DE 91 14 787 U by the applicant. The spring of the retraction device must in that case be strong enough to move against the resistance of the return spring and of the damping fluid when the cylinder 16 closes.

1. Mounting plate for a linear damper with a cylinder, a piston and a piston rod, whereby the cylinder of the linear damper is held between holding jaws of the mounting plate, characterised in that the holding jaws of the mounting plate form a loose bearing in which the cylinder is axially displaceable.

2. Mounting plate according to claim 1, characterised in that the mounting plate which is rectangular in top view has lateral grooves and a frontally projecting hook.

3. Mounting plate according to claim 2 characterised in that the grooves are formed on one end of the mounting plate and the hook at the opposite end.

4. Mounting plate according to claim 1, characterised in that the cylinder of the linear damper is held resiliently or spring-clamped by the holding jaws.

5. Mounting plate according to claim 1, characterised in that the holding jaws form stops which limit the axial displacement movement of the cylinder.

6. Mounting plate according to claim 1, characterised in that the holding jaws encompass more than 180° of the perimeter of the cylinder.

7. Mounting plate according to claim 1, characterised in that the holding jaws encompass between 190° and 260° of the perimeter of the cylinder.

8. Mounting plate according to claim 1, characterised in that the holding jaws encompass between 200° and 230° of the perimeter of the cylinder.

9. Mounting plate according to claim 1, characterised in that the mounting plate has a wall which forms a stop for the piston rod of the linear damper.

10. Mounting plate according to claim 9, characterised in that the wall is disposed on one front face of the mounting plate.

11. Mounting plate according to claim 1, characterised in that the mounting plate has a trough-shaped area in which the linear damper is accomodated.

12. Mounting plate according to claim 11 characterised in that the trough-shaped area extends over 160° to 180° of the perimeter of the cylinder.

13. Damper arrangement for movable furniture parts, with a damper having a moving damper part and a stop which can travel relative to the damper, said stop impacts on the moving damper part during the damping process and thus effects the damping, for use with a mounting plate according to claim 1, characterised in that the stop consists at least partially of a material with rubber elastic properties.

14. Damper arrangement according to claim 13, characterised in that the stop consists at least partially of an elastomer.

15. Damper arrangement according to claim 13, characterised in that the stop consists of a metallic tab or the like and a cap placed upon it, said cap is made at least partially of a material with rubber elastic properties.

16. Damper arrangement according to claim 15, characterised in that the cap is made of synthetic material.

17. Damper arrangement according to claim 15, characterised in that the cap is made of an elastomer.

18. Damper arrangement according to claim 13, characterised in that at least one part of the stop is formed by a two-component moulded part with hard carrier material and soft striking material.

19. Damper arrangement according to claim 15, characterised in that the cap is formed by a two-component moulded part with hard carrier material and soft striking material.

20. Damper arrangement according to claim 13, characterised in that the movable damper part strikes laterally against the stop or the cap during the damping process.

21. Damper arrangement according to claim 13, characterised in that the damper is designed as a linear damper having a cylinder and a piston located in said cylinder, said piston having a piston rod, whereby the cylinder impacts on the stop during the damping process.

22. Damper arrangement according to claim 13, characterised in that the damper and the stop are disposed on rails of a pull-out guide rail for drawers.

23. Damper arrangement according to claim 22, characterised in that the damper is disposed on a mounting rail fitted to a body of furniture and the stop is disposed on a drawer rail fitted to the drawer.

24. Pull-out guide rail for drawers or the like with a drawer rail fitted to the drawer and a mounting rail fitted to the body of furniture, whereby a linear damper is mounted on bearings on one of the rails, said linear damper brakes the drawer rail, characterised in that the linear damper rests on one of the rails by means of a mounting plate according to claim 1.

25. Pull-out guide according to claim 24, characterised in that the linear damper rests on the mounting rail by means of the mounting plate.

26. Pull-out guide according to claim 24, characterised in that the rail on which the mounting plate is anchored has a ridge with a longitudinal slot, whereby the mounting plate is inserted in the longitudinal slot in such a way that the lateral edges of the slot project into the lateral grooves of the mounting plate and the hook on the front end of the mounting plate snaps in a recess of the ridge, said recess being provided on the front face of the longitudinal slot and at a distance therefrom.

27. Pull-out guide according to claim 26, characterised in that the ridge with the longitudinal slot is anchored on the mounting rail.

28. Pull-out guide according to claim 26, characterised in that the other rail is provided with a stop which strikes against the cylinder of the linear damper.

29. Pull-out guide according to claim 28, characterised in that the drawer rail is provided with a stop which strikes against the cylinder of the linear damper.

30. Pull-out guide according to claim 24, characterised in that the cylinder of the linear damper has two lateral stops which, when the linear damper is in the ready position, abut against front edges of the holding jaws.

31. Pull-out guide according to claim 24, characterised in that it is provided with a retraction device for the drawer rail.
